(19) United States
(12) Patent Application Publication
(10) Pub. No.: US 2014/0107950 A1
(43) Pub. Date: Apr. 17, 2014

(54) BANDPASS ADC SAMPLING FOR FLUID VELOCITY DETERMINATION

(71) Applicant: TEXAS INSTRUMENTS INCORPORATED, Dallas, TX (US)

(72) Inventors: Anand Dabak, Plano, TX (US); Venkata Ramanan, Tucson, AZ (US)

(73) Assignee: TEXAS INSTRUMENTS INCORPORATED, Dallas, TX (US)

(21) Appl. No.: 14/051,623

(22) Filed: Oct. 11, 2013

Related U.S. Application Data
(60) Provisional application No. 61/713,385, filed on Oct. 12, 2012.

(51) Int. Cl. G01F 1/66

(52) U.S. Cl. CPC G01F 1/66
USPC 702/48

(57) ABSTRACT

A method of calculating a time difference is disclosed. The method includes receiving a first ultrasonic signal (r²¹) having a first frequency from a first transducer (UT₂) at a first time and receiving a second ultrasonic signal (r¹²) having the first frequency from a second ultrasonic transducer (UT₂) at a second time. The first ultrasonic signal and the second ultrasonic signal are sampled at a second frequency (302). The first sampled ultrasonic frequency is interpolated (306). The difference in travel time between the first and second ultrasonic signals is calculated in response to the interpolated first sampled ultrasonic signal and the sampled second ultrasonic signal (equation [43]).

### BACKGROUND OF THE INVENTION

This application claims the benefit of U.S. Provisional Application No. 61/713,385 (TI-72924PS), filed Oct. 12, 2012, and incorporated by reference herein in its entirety.

Embodiments of the present invention relate to band pass analog-to-digital (ADC) sampling of ultrasonic signals to determine fluid velocity.

Ultrasound technology has been developed for measuring fluid velocity in a pipe of known dimensions. Typically, these measurement solutions use only analog processing and limit the accuracy and flexibility of the solution. Ultrasound velocity meters may be attached externally to pipes, or ultrasound transducers may be places within the pipes. Fluid flow may be measured by multiplying fluid velocity by the interior area of the pipe. Cumulative fluid volume may be measured by integrating fluid flow over time.

FIG. 1 illustrates an example of positioning ultrasonic transducers for fluid velocity measurement. There are many alternative configurations, and FIG. 1 is just an example for the purpose of illustrating some basic equations for ultrasound measurement of fluid velocity. Two ultrasonic transducers UT₁ and UT₂ are mounted inside a pipe 100, and a fluid is flowing through the pipe with velocity V. L is the distance between the ultrasonic transducers UT₁ and UT₂ and θ is the angle between the dashed line connecting the transducers and the wall of the pipe. Propagation time t₁₂ or time of flight (TOF) is the time for an ultrasonic signal to travel from UT₁ to UT₂ within the fluid Likewise, propagation time t₂₁ is the TOF for an ultrasonic signal to travel from UT₂ to UT₁ within the fluid. If C is the velocity of the ultrasonic signal in the fluid and V is the velocity of the fluid in pipe 100, these propagation times are given by equations [1] and [2].

$$\begin{matrix}{t}_{12} = \frac{L}{C + V cos ( θ )} & [ 1 ] \\ {t}_{21} = \frac{L}{C - V cos ( θ )} & [ 2 ]\end{matrix}$$

The angle θ and the distance L are known, and the objective is to measure the fluid velocity V. If the velocity C of the ultrasonic signal in the fluid is known, then only the difference between propagation times t₁₂ and t₂₁ is needed. However, the velocity C is a function of temperature, and a temperature sensor may or may not be included based on the target cost of the measurement system. In addition, a flow meter may be used for different fluids such as water, heating oil, and gas. Measuring two different propagation times (t₁₂ and t₂₁) cancels the variability of C. Combining equations [1] and [2] yields equation [3] for the fluid velocity V.

$$V = \frac{L}{2} * \frac{{t}_{21} - {t}_{12}}{{t}_{21} {t}_{12}} \qquad [ 3 ]$$

Therefore, to determine fluid velocity without knowing the velocity of an ultrasonic signal in the fluid, measurement of two ultrasonic propagation times (t₁₂ and t₂₁) are needed. The present inventors have realized a need to improve measurement techniques in terms of cost and accuracy. Accordingly, the preferred embodiments described below are directed toward improving upon the prior art.

### BRIEF SUMMARY OF THE INVENTION

In a preferred embodiment of the present invention, a method of calculating a time difference is disclosed. The method includes receiving a first ultrasonic signal having a first frequency from a first transducer at a first time and receiving a second ultrasonic signal having the first frequency from a second ultrasonic transducer at a second time. The first and second ultrasonic signals are sampled at a second frequency. The first sampled ultrasonic signal is interpolated so it is aligned in time with the first sampled ultrasonic signal. A difference in travel time of the first and second ultrasonic signals is calculated in response to the interpolated first sampled ultrasonic signal and the sampled second ultrasonic signal.

### BRIEF DESCRIPTION OF THE SEVERAL VIEWS OF THE DRAWING

FIG. 1 is a diagram of a pipe with ultrasonic transducers for fluid flow measurement according to the prior art;

FIG. 2 is a circuit diagram of an ultrasonic mixer based receiver of the present invention for measuring fluid flow;

FIG. 3A is a circuit diagram of an ultrasonic intermediate frequency (IF) sampling based receiver of the present invention for measuring fluid flow;

FIG. 3B is a circuit diagram of the signal processing circuit of FIG. 3A;

FIG. 4 is graph illustrating Farrow cubic interpolation that may be used with the circuit of FIG. 3B;

FIG. 5A is diagram showing the excitation signal applied to a transmitting transducer for transmission to a receiving transducer as 1, 10, or 20 pulses;

FIG. 5B is diagram showing the signal at the receiving transducer in response to 1, 10, or 20 pulses at a transmitting transducer;

FIG. 6 is graph showing accuracy of the measurement circuit of FIG. 3A compared to zero crossing and cross correlation measurement techniques;

FIG. 7 is graph showing accuracy of the measurement circuit of FIG. 3A compared to zero crossing and cross correlation measurement techniques with different numbers of ADC bits and different numbers of transducer excitation pulses;

FIG. 8 is graph showing accuracy of the measurement circuit of FIG. 3A for a 12-bit ADC having positive sampling frequency misalignment with respect to the optimal ADC sampling frequency;

FIG. 9 is graph showing accuracy of the measurement circuit of FIG. 3A for a 12-bit ADC having negative sampling frequency misalignment with respect to the optimal ADC sampling frequency; and

FIG. 10 is a table summarizing accuracy of the measurement circuit of FIG. 3A for various conditions.

### DETAILED DESCRIPTION OF THE INVENTION

The preferred embodiments of the present invention provide significant advantages of ultrasonic differential time of flight (TOF) measurement techniques in a fluid medium over methods of the prior art as will become evident from the following detailed description.

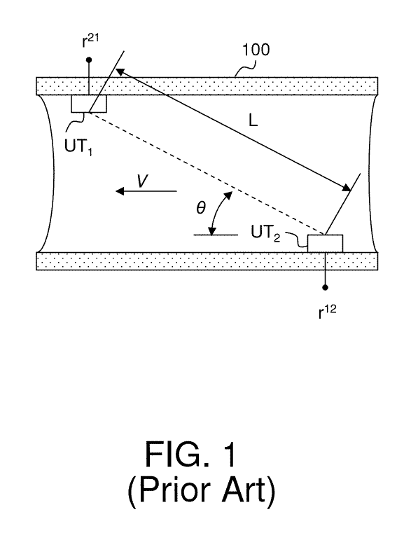

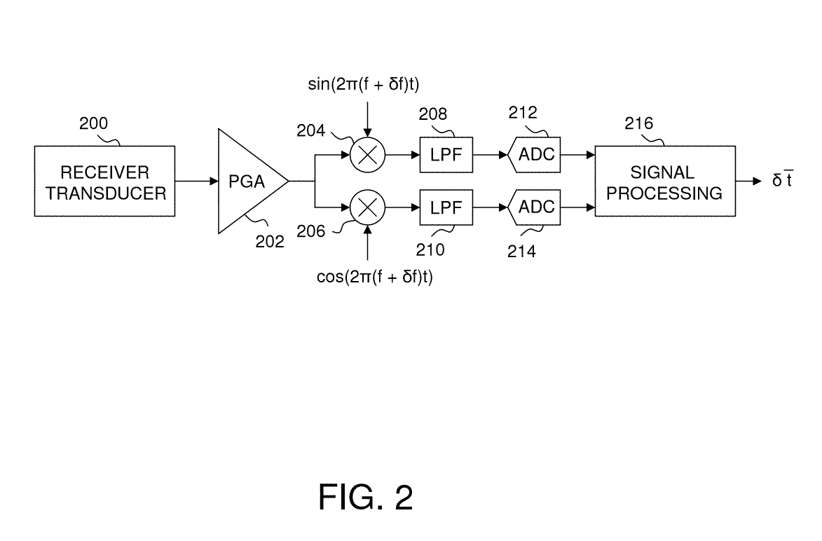

Referring to FIG. 2, there is a mixer based measurement circuit of the present invention for measuring differential time of flight (δt) of ultrasonic signals in a fluid medium. Here and in the following discussion, some circuit functions may be realized in hardware, software, or a combination of hardware and software as will be apparent to one of ordinary skill in the art having access to the instant specification. This circuit advantageously converts ultrasonic transducer signals to a lower intermediate frequency (IF), thereby permitting a lower analog to digital converter (ADC) sampling rate. Referring back to FIG. 1, signal r¹² is the ultrasonic signal produced by transducer UT₁ and received from transducer UT₂ as given by equation 4 Likewise, signal r²¹ is the ultrasonic signal produced by transducer UT₂ and received from transducer UT₁ as given by equation 5. The center frequency of the transmitting transducer is f_{C}, and f(t) is the envelope of the received signal.

r¹²=f(t)sin(2πf_{C}t) [4]

r²¹=f(t+δt)sin(2πf_{C}(t+δt)) [5]

The receiver transducer 200 of FIG. 2 preferably receives the signals of equations [4] and [5] alternately so that transducer UT₁ transmits when transducer UT₂ receives, and transducer UT₂ transmits when transducer UT₁ receives. The received signals are amplified by programmable gain amplifier (PGA) 202 and applied to mixer circuits 204 and 206. Mixer circuit 204 multiplies the received signal by the modulating signal sin(2π(f_{C}+δf)t) and applies the resulting in phase signal to low pass filter (LPF) 208. Mixer circuit 206 multiplies the received signal by the modulating signal cos(2π(fC+δf)t) and applies the resulting quadrature signal to low pass filter (LPF) 210. Here, δf is a frequency error term of the mixer frequency with respect to the transducer center frequency. The output signals from in phase mixer 204 are given by equations [6] and [7]. The output signals from quadrature mixer 206 are given by equations [8] and [9].

r_{I}¹²(t)=f(t)sin(2πf_{C}t)sin(2π(f_{C}+δf)t) [6]

r_{I}²¹(t)=f(t+δt)sin(2πf_{C}(t+δt))sin(2π(f_{C}+δf)t) [7]

r_{Q}¹²(t)=f(t)sin(2πf_{C}t)cos(2π(f_{C}+δf)t) [8]

r_{Q}²¹(t)=f(t+δt)sin(2πf_{C}(t+δt))cos(2π(f_{C}+δf)t) [9]

The output signals from LPF 208 are given by equations [10] and [11]. The output signals from LPF 210 are given by equations [12] and [13]. Here, the signal pair of equations [11] and [13] is not a delayed version of the signal pair of equations [10] and [12]. By way of contrast, the received signal of equation [5] is a delayed version of the signal of equation [4].

\tilde{r}_{I}¹²(t)=f(t)sin(2πδft) [10]

\tilde{r}_{I}²¹(t)=f(t+δt)sin(2π(f_{C}δt+δft)) [11]

\tilde{r}_{Q}¹²(t)=f(t)cos(2πδft) [12]

\tilde{r}_{Q}²¹(t)=f(t+δt)cos(2π(f_{C}δt+δft)) [13]

Analog to digital converter (ADC) 212 converts the analog signals from LPF 208 (equations [10] and [11]) to digital signals and applies them to signal processing circuit 216 Likewise, ADC 214 converts the analog signals from LPF 210 (equations [12] and [13]) to digital signals and applies them to signal processing circuit 216. Processing circuit 216 is preferably a digital signal processor and estimates the differential TOF (60 according to equation [14].

$$δ t = a tan ( \frac{{\tilde{r}}_{Q}^{21} ( t )}{{\tilde{r}}_{I}^{21} ( t )} ) - a tan ( \frac{{\tilde{r}}_{Q}^{12} ( t )}{{\tilde{r}}_{I}^{12} ( t )} ) \qquad [ 14 ]$$

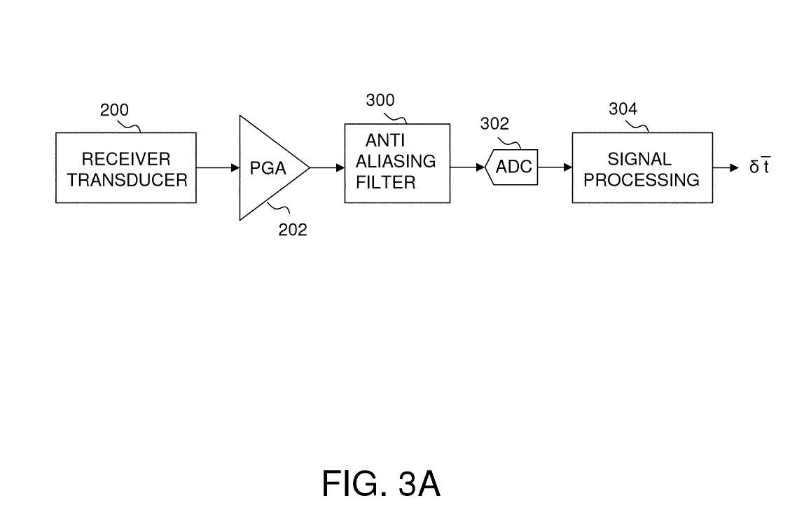

Referring now to FIG. 3A, there is a circuit diagram of an ultrasonic intermediate frequency (IF) sampling based receiver of the present invention for measuring fluid flow differential time of flight (δt) of ultrasonic signals in a fluid medium. Here and in the following discussion, the same reference numerals are used to indicate substantially the same circuit elements. The receiver transducer 200 of FIG. 3A preferably receives the signals of equations [4] and [5] alternately so that transducer UT₁ transmits when transducer UT₂ receives, and transducer UT₂ transmits when transducer UT₁ receives. The received signals are amplified by programmable gain amplifier (PGA) 202 and applied to anti aliasing filter 300. The output signal from anti aliasing filter 300 is then applied to analog-to-digital converter (ADC) 302. This embodiment of the present invention advantageously samples the received signal from anti aliasing filter 300 at an intermediate frequency (IF) so that ADC 302 may sample at a lower frequency as given by equation [15]. The corresponding sample time is given by equation [16]. Here, K is an integer indicating the sampling frequency, and N is an integer indicating the N^{th} sample.

$$\begin{matrix}{f}_{SAMP} = \frac{{f}_{C}}{\frac{1}{4} + \frac{K}{2}} & [ 15 ] \\ {t}_{SAMP}^{N} = \frac{N}{{f}_{SAMP}} & [ 16 ]\end{matrix}$$

ADC 302 preferably alternately produces the sample signals of equations [17] and [18] at a sampling rate determined by equations [15] and [16].

$$\begin{matrix}{r}^{12} ( N ) = f ( {t}_{SAMP}^{N} ) sin ( 2 π {f}_{C} ( \frac{N ( 1 / 4 + K / 2 )}{{f}_{C}} + {t}_{off} ) ) & [ 17 ] \\ {r}^{21} ( N ) = f ( {t}_{SAMP}^{N} + δ t ) sin ( 2 π {f}_{C} ( \frac{N ( 1 / 4 + K / 2 )}{{f}_{C}} + δ t + {t}_{off} ) ) & [ 18 ]\end{matrix}$$

Equations [17] and [18] are simplified and rewritten as equations [19] and [20].

$$\begin{matrix}{r}^{12} ( N ) = f ( {t}_{SAMP}^{N} + {t}_{off} ) sin ( π N ( \frac{1}{2} + K ) + 2 π {f}_{C} {t}_{off} ) & [ 17 ] \\ {r}^{21} ( N ) = f ( {t}_{SAMP}^{N} + {t}_{off} + δ t ) sin ( π N ( \frac{1}{2} + K ) + 2 π {f}_{C} ( {t}_{off} + δ t ) ) & [ 18 ]\end{matrix}$$

For K even and N=0, 1, 2, 3, r¹²(N) is given by equations [19] through [22], respectively. The pattern of equations [19] through [22] repeats for larger N.

r¹²(0)=f(t_{SAMP}⁰+t_{off})sin(2πf_{C}t_{off}) [19]

r¹²(1)=f(t_{SAMP}¹+t_{off})cos(2πf_{C}t_{off}) [20]

r¹²(2)=−f(t_{SAMP}²+t_{off})sin(2πf_{C}t_{off}) [21]

r¹²(3)=−f(t_{SAMP}³+t_{off})cos(2πf_{C}t_{off}) [22]

For K odd and N=0, 1, 2, 3, r¹²(N) is given by equations [23] through [26], respectively. The pattern of equations [23] through [26] repeats for larger N.

r¹²(0)=f(t_{SAMP}⁰+t_{off})sin(2πf_{C}t_{off}) [23]

r¹²(1)=−f(t_{SAMP}¹+t_{off})cos(2πf_{C}t_{off}) [24]

r¹²(2)=−f(t_{SAMP}²+t_{off})sin(2πf_{C}t_{off}) [25]

r¹²(3)=f(t_{SAMP}³+t_{off})cos(2πf_{C}t_{off}) [26]

Similarly, for K even and N=0, 1, 2, 3, r²¹(N) is given by equations [27] through [30], respectively. The pattern of equations [27] through [30] repeats for larger N.

r²¹(0)=f(t_{SAMP}⁰+t_{off}+δt)sin(2πf_{C}(t_{off}+δt)) [27]

r²¹(1)=f(t_{SAMP}¹+t_{off}+δt)cos(2πf_{C}(t_{off}+δt)) [28]

r²¹(2)=−f(t_{SAMP}²+t_{off}+δt)sin(2πf_{C}(t_{off}+δt)) [29]

r²¹(3)=−f(t_{SAMP}³+t_{off}+δt)cos(2πf_{C}(t_{off}+δt)) [30]

Likewise, for K odd and N=0, 1, 2, 3, r²¹(N) is given by equations [31] through [34], respectively. The pattern of equations [31] through [34] repeats for larger N.

r²¹(0)=f(t_{SAMP}⁰+t_{off}+δt)sin(2πf_{C}(t_{off}+δt)) [31]

r²¹(1)=−f(t_{SAMP}¹+t_{off}+δt)cos(2πf_{C}(t_{off}+δt)) [32]

r²¹(2)=−f(t_{SAMP}²+t_{off}+δt)sin(2πf_{C}(t_{off}+δt)) [33]

r²¹(3)=−f(t_{SAMP}³+t_{off}+δt)cos(2πf_{C}(t_{off}+δt)) [34]

The sine terms for r¹² and K even are collected from equations [19], [21], and repeated N in equation [35]. The cosine terms for r¹² and K even are collected from equations [20], [22], and repeated N in equation [36].

r_{Keven}¹²(N)={f(t_{SAMP}⁰+t_{off}),−f(t_{SAMP}²+t_{off}), . . . }sin(2πf_{C}t_{off}) [35]

r_{Keven}¹²(N)={f(t_{SAMP}¹+t_{off}),−f(t_{SAMP}³+t_{off}), . . . }cos(2πf_{C}t_{off}) [36]

Similarly, the sine terms for r²¹ and K even are collected from equations [27], [29], and repeated N in equation [37]. The cosine terms for r¹² and K even are collected from equations [28], [30], and repeated N in equation [38].

r_{Keven}²¹(N)={f(t_{SAMP}⁰+t_{off}δt),−f(t_{SAMP}²+t_{off}+δt), . . . }sin(2πf_{C}(t_{off}+δt)) [37]

r_{Keven}²¹(N)={f(t_{SAMP}¹+t_{off}δt),−f(t_{SAMP}³+t_{off}+δt), . . . }cos(2πf_{C}(t_{off}+δt)) [38]

Comparing the sine terms of equation [35] with those of equation [37] and the cosine terms of equation [36] with those of equation [38], the sampling functions differ in time by offset δt. The cosine terms of equations [36] through [38], therefore, are interpolated to match the timing of the sine terms in equations [39] and [42], respectively.

r_{Keven,sin}¹²(N)={f(t_{SAMP}⁰+t_{off}),−f(t_{SAMP}²+t_{off}), . . . }sin(2πf_{C}t_{off}) [39]

r_{Keven,cos}^{12,int}(N)={\tilde{f}(t_{SAMP}⁰+t_{off}),−\tilde{f}(t_{SAMP}²+t_{off}), . . . }cos(2πf_{C}t_{off}) [40]

r_{Keven,sin}²¹(N)={f(t_{SAMP}⁰+t_{off}),−f(t_{SAMP}²+t_{off}), . . . }sin(2πf_{C}t_{off}) [41]

r_{Keven,cos}^{21,int}(N)={\tilde{f}(t_{SAMP}⁰+t_{off}+δt),−\tilde{f}(t_{SAMP}²+t_{off}+δt), . . . }cos(2πf_{C}t_{off}) [42]

Referring to FIG. 3B, there is a signal processing circuit 304 to perform the foregoing calculations in equations [39] through [42]. Sine terms from ADC 302 are applied to sum circuit 310 where they are accumulated and applied to processing circuit 312. Cosine terms from ADC 302 are interpolated by block 306 and applied to sum circuit 308. Sum circuit 308 accumulates the cosine terms and applies them to processing circuit 312. Processing circuit 312 estimates the differential TOF (δt) according to equation [43].

$$δ t = \frac{\begin{matrix}angle ( \sum {r}_{Keven , cos}^{21 , int} / \sum {r}_{Keven , sin}^{21} ) - \\ angle ( \sum {r}_{Keven , cos}^{21 , int} / \sum {r}_{Keven , sin}^{21} )\end{matrix}}{2 π {f}_{C}} \qquad [ 43 ]$$

Estimation accuracy of the differential TOF (δt) of equation [43] relies on the fact that the summed f sampling coefficients of equations [39] through [42] are close to each other in time. Of course, for increasing δt, the estimation error also increases. Transmitting a larger number of pulses from each transducer reduces the variation of the summed f sampling coefficients by increasing signal duration and, therefore, improves accuracy. At least a 1% measurement accuracy is desirable. A most demanding condition for this measurement is assumed for a differential TOF of approximately 3 ns. This corresponds to a 6 cm transducer spacing and a 5 cm/s flow rate. A 1% error for this condition requires an error of less than 30 ps for a 6σ measurement.

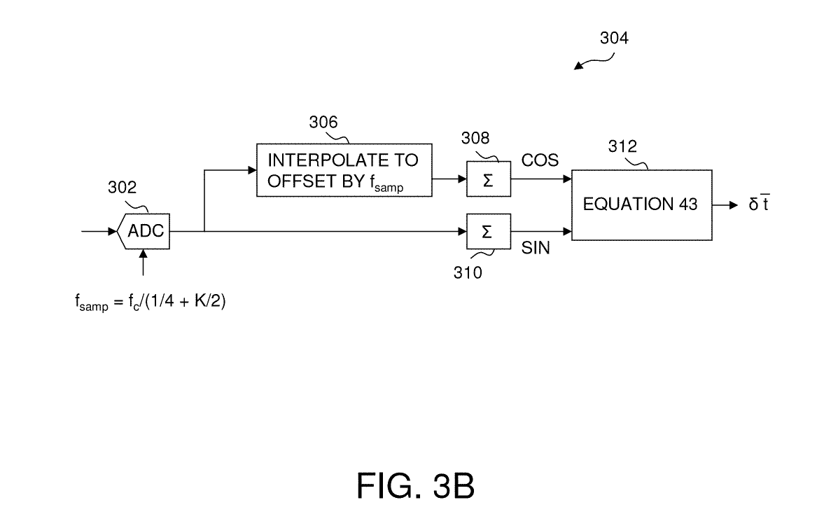

FIG. 4 is graph illustrating Farrow cubic interpolation that may be used with the circuit of FIG. 3B as in equations [40] and [42]. This and other interpolation techniques are disclosed by Erup et al., “Interpolation in digital modems—Part II: Implementation and performance”, IEEE Trans. on Communications, Vol. 41, No. 6, 998-1008 (June 1993). The principle of Farrow cubic interpolation is given by equation [44].

$$Y ( k ) = {λ}^{3} ( \frac{x ( i + 2 )}{6} - \frac{x ( i + 1 )}{2} + \frac{x ( i )}{2} - \frac{x ( i - 1 )}{6} ) + {λ}^{2} ( \frac{x ( i + 1 )}{2} - x ( i ) + \frac{x ( i - 1 )}{2} ) + … λ ( - \frac{x ( i + 2 )}{6} + x ( i + 1 ) - \frac{x ( i )}{2} - \frac{x ( i - 1 )}{3} ) + x ( i ) \qquad [ 44 ]$$

Here, λ is the interpolation factor and k is the output sample index. To is the time between output samples and Ti is the time between input samples. In a preferred embodiment of the present invention, λ is ½. If the ADC sampling frequency is taken as 4/3 (1.733 MHz) or ⅘ (1.04 MHz) of the transducer excitation frequency, it is only necessary to interpolate the summed cosine (Q channel) terms. According to a preferred embodiment of the present invention, this may be accomplished by dividing a 5.2 MHz clock by 4 to produce the 1.3 MHz excitation frequency. The same 5.2 MHz clock may be divided by 3 to produce a 1.733 MHz sampling frequency or by 5 to produce a 1.04 MHz sampling frequency. Both the excitation frequency and the sampling frequency, therefore, are advantageously synchronized. Although some variation of sampling frequency with respect to excitation frequency is possible, the sampling frequency is preferably constrained to +/−5% of the target sampling frequency. Each x(.) term of equation [44] represents a sampled input f(.) from equations [36] and [38]. These input terms are used to interpolate output terms Y(k) or \tilde{f}(.) terms of equations [40] and [42], respectively. These interpolated terms are time shifted so that they are aligned with the summed sine (I channel) terms. Thus, the superscripts of the interpolated terms are changed to match the summed cosine terms.

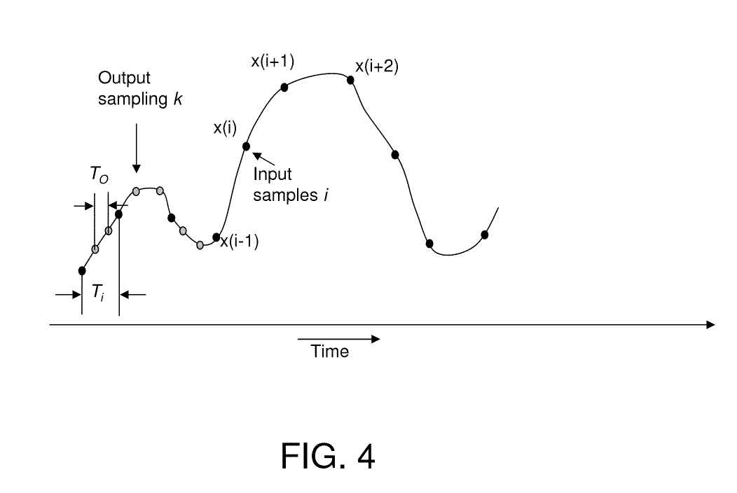

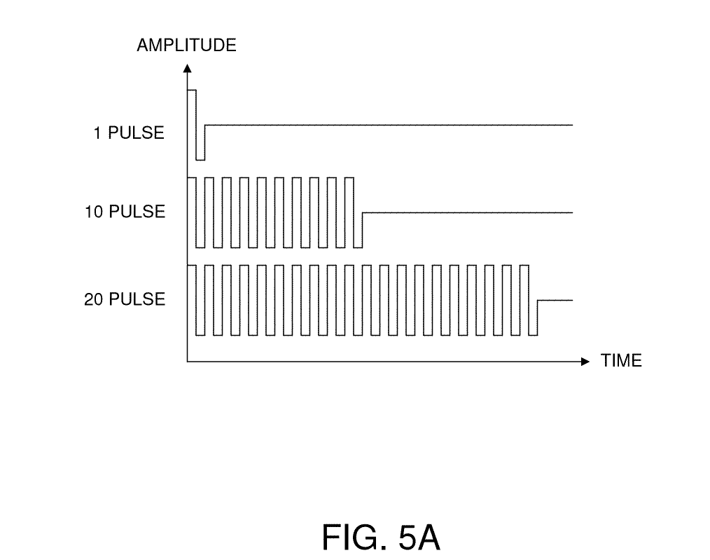

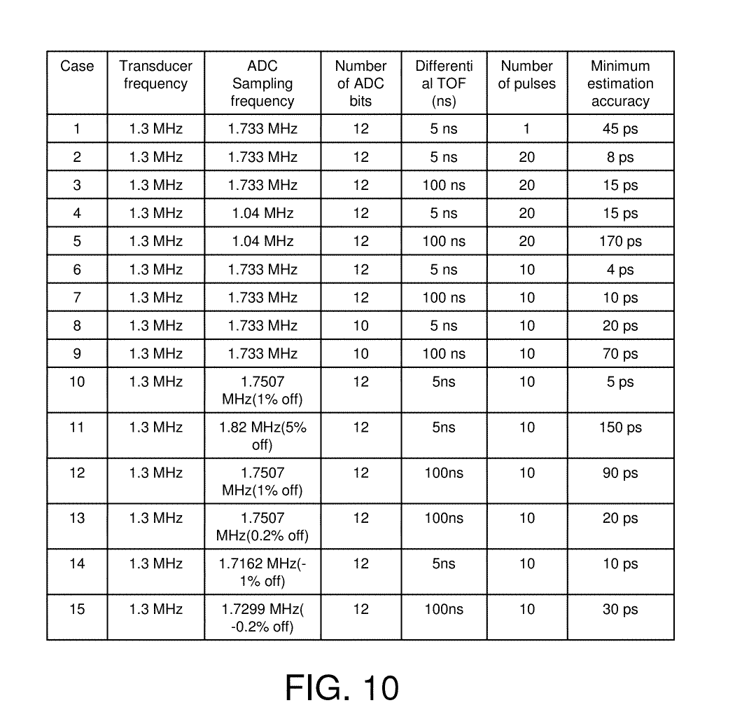

FIG. 5A is diagram showing the pulse excitation signal applied to a transmitting transducer as 1, 10, or 20 pulses for transmission to receiving transducer. FIG. 5B is graph showing the signal at the receiving transducer in response to 1, 10, and 20 pulses at a transmitting transducer. Preferred embodiments of the present invention utilize transducers with a center frequency (f_{C}) of 1.3 MHz. However, other transducers and different center frequencies may also be used. The diagram illustrates the resonance of a transmitting transducer in response to 1, 10, and 20 input pulses. In each case, the envelope of the resonant signal rises to a peak amplitude corresponding to the duration of the pulses. After this the envelope of each signal decays as in a typical RLC circuit. For example, 20 pulses at 1.3 MHz have a duration of t=20/1.3e6=15.4 μs. A 10 pulse excitation signal has a duration of t=10/1.3e6=7.7 μs. Several simulations are given at FIGS. 6-9 for various numbers of input pulses to demonstrate the accuracy of the measurement system of FIG. 3A for a transducer center frequency (f_{C}) of 1.3 MHz. Results for 15 different conditions are summarized at the table in FIG. 10.

Referring now to FIG. 6, there is graph showing accuracy of the measurement circuit of FIG. 3A compared to zero crossing and cross correlation measurement techniques. The vertical scale is root mean squared (RMS) error of the differential TOF estimation as a function of noise. Simulations show less than 1% RMS for all IF sampling except 1.04 MHz sampling and 20 pulse transmission at 5 ns δt and 1.733 MHz sampling and 1 pulse transmission at 5 ns δt. Other simulations, however, show low tolerance to noise. IF sampling at 1.04 MHz sampling and 20 pulse transmission at 100 ns δt and 1.733 MHz sampling and 20 pulse transmission at 100 ns δt maintain less than 1% RMS error to 40 dBnV/sqrt(Hz).

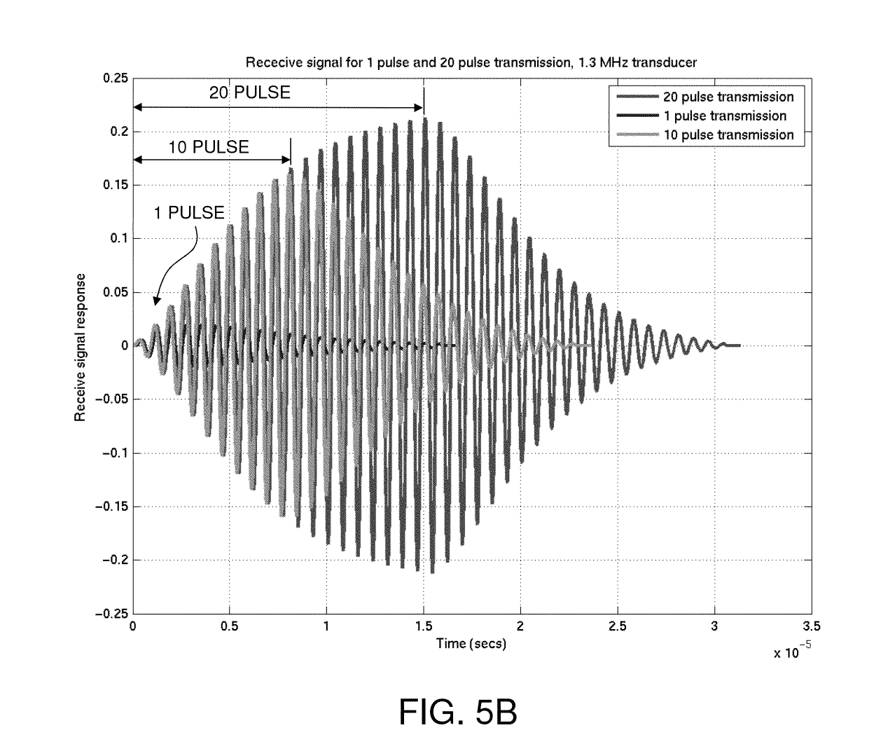

Referring now to FIG. 7, there is graph showing accuracy of the measurement circuit of FIG. 3A compared to zero crossing and cross correlation measurement techniques with different numbers of ADC bits and different numbers of transducer excitation pulses. The vertical scale is root mean squared (RMS) error of the differential TOF estimation as a function of noise. All IF sampling simulations are at 1.733 MHz. The greatest noise tolerance is 20 pulse transmission at either 5 ns or 100 ns δt. Both maintain less than 1% RMS error to 40 dBnV/sqrt(Hz).

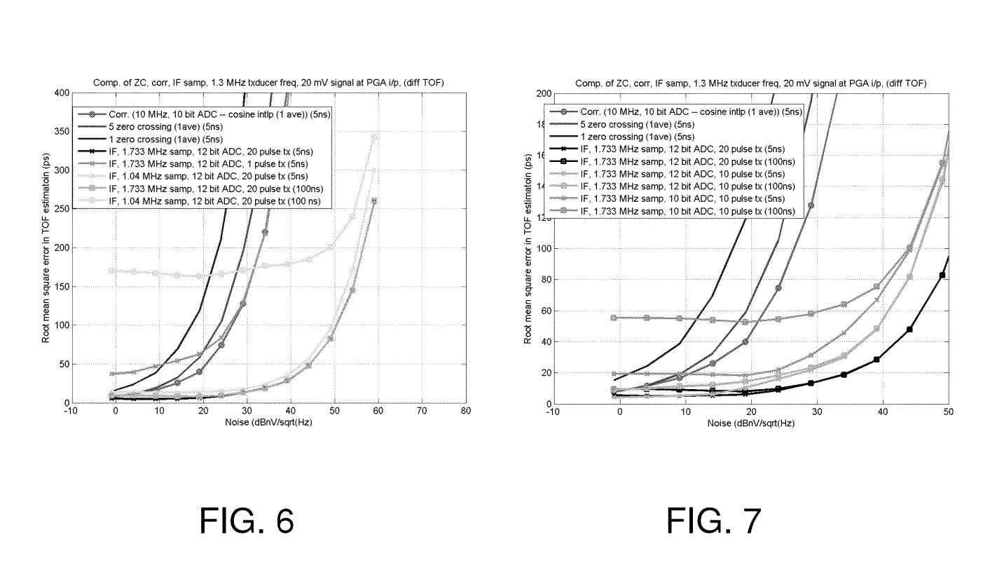

Referring now to FIG. 8, there is graph showing accuracy of the measurement circuit of FIG. 3A for a 12-bit ADC having positive sampling frequency misalignment with respect to the optimal ADC sampling frequency accuracy of the measurement circuit of FIG. 3A compared to zero crossing and cross correlation measurement techniques. The vertical scale is root mean squared (RMS) error of the differential TOF estimation as a function of noise. All IF sampling simulations compare results of a desired 1.733 MHz sampling frequency with positive sampling frequency errors of 0.2%, 1%, and 5%.

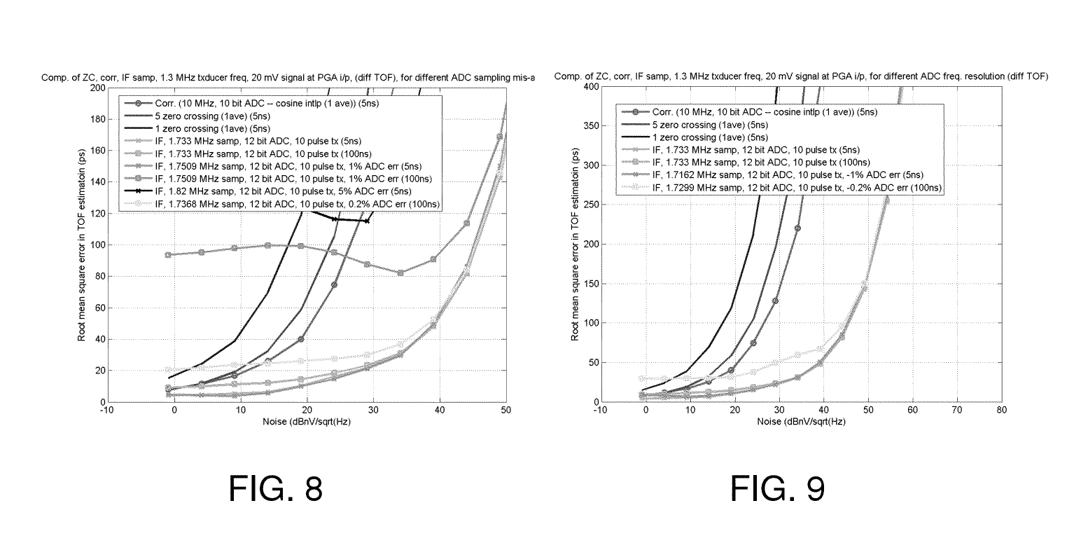

Referring now to FIG. 9, there is graph showing accuracy of the measurement circuit of FIG. 3A for a 12-bit ADC having negative sampling frequency misalignment with respect to the optimal ADC sampling frequency accuracy of the measurement circuit of FIG. 3A compared to zero crossing and cross correlation measurement techniques. The vertical scale is root mean squared (RMS) error of the differential TOF estimation as a function of noise. All IF sampling simulations compare results of a desired 1.733 MHz sampling frequency with negative sampling frequency errors of −0.2% and −1%.

FIG. 10 is a table summarizing accuracy of the measurement circuit of FIG. 3A for various conditions. These conditions include variation of ADC sampling frequency, number of ADC bits, differential TOF (δt), and number of transducer pulses.

Still further, while numerous examples have thus been provided, one skilled in the art should recognize that various modifications, substitutions, or alterations may be made to the described embodiments while still falling within the inventive scope as defined by the following claims. Other combinations will be readily apparent to one of ordinary skill in the art having access to the instant specification.

What is claimed is:

1. A method of calculating a time difference, comprising:
receiving a first ultrasonic signal transmitted at a first frequency from a first transducer at a first time;
receiving a second ultrasonic signal transmitted at the first frequency from a second transducer at a second time;
sampling the first ultrasonic signal at a second frequency to produce a first sampled ultrasonic signal;
sampling the second ultrasonic signal at the second frequency to produce a second sampled ultrasonic signal; and
calculating the time difference in response to the first and second sampled ultrasonic signals.

2. A method as in claim 1, comprising interpolating at least one of the first and second ultrasonic signals to produce the first sampled ultrasonic signal.

3. A method as in claim 1, wherein the first frequency and the second frequency are divided from a single clock frequency.

4. A method as in claim 1, wherein the second frequency is one of 4/3 and ⅘ of the first frequency.

5. A method as in claim 1, wherein the first ultrasonic signal is a cosine term, and wherein the second ultrasonic signal is a sine term.

6. A method as in claim 1, wherein the first sampled ultrasonic signal is a sum of first ultrasonic signal terms, and wherein the second sampled ultrasonic signal is a sum of second ultrasonic signal terms.

7. A method as in claim 1, wherein the first frequency is an excitation frequency of a transmitting transducer.

8. A method as in claim 1, wherein the second frequency is an analog-to-digital (ADC) sampling frequency equal to the first frequency divided by (¼+K/2), where K is an integer.

9. A method as in claim 1, comprising:
receiving the first ultrasonic signal at the second transducer; and
receiving the second ultrasonic signal at the first transducer.

10. A method of calculating a time difference, comprising:
receiving a first ultrasonic signal transmitted at a first frequency from a first transducer;
receiving a second ultrasonic signal transmitted at the first frequency from a second transducer;
mixing the first ultrasonic signal with a first signal to produce an in phase signal;
mixing the second ultrasonic signal with a second signal to produce a quadrature signal;
sampling the in phase signal;
sampling the quadrature signal; and
calculating the time difference in response to the sampled in phase signal and the sampled quadrature signal.

11. A method as in claim 10, wherein the time difference is a difference in transit time of the first ultrasonic signal from the first transducer to the second transducer and of the second ultrasonic signal from the second transducer to the first transducer.

12. A method as in claim 10, comprising:
receiving the first ultrasonic signal by the second transducer; and
receiving the second ultrasonic signal by the first transducer.

13. A system for measuring material flow in a pipe, comprising:
a first ultrasonic transducer arranged to transmit a first signal having a first frequency at a first time and receive a second signal at a second time;
a second ultrasonic transducer spaced apart from the first ultrasonic transducer and arranged to receive the first signal and transmit the second signal having the first frequency;
an analog-to-digital converter (ADC) arranged to sample the received first signal at a second frequency and produce a first sampled signal, the ADC arranged to sample the received second signal at the second frequency and produce a second sampled signal; and
a processing circuit arranged to calculate a time difference in response to the first and second sampled ultrasonic signals and calculate the material flow in response to the time difference.

14. A system as in claim 13, comprising a circuit for interpolating the first sampled signal.

15. A system as in claim 13, comprising a circuit for interpolating the second sampled signal.

16. A system as in claim 13, wherein the second frequency is one of 4/3 and ⅘ of the first frequency.

17. A system as in claim 13, wherein the first signal is a cosine term, and wherein the second signal is a sine term.

18. A system as in claim 13, wherein the first sampled signal is a sum of first signal terms, and wherein the second sampled signal is a sum of second signal terms.

19. A system as in claim 13, wherein the second frequency is an analog-to-digital (ADC) sampling frequency equal to the first frequency divided by (¼+K/2), where K is an integer.

20. A system as in claim 13, wherein the first ultrasonic transducer is affixed to a first surface of the pipe, and wherein the second ultrasonic transducer is affixed to a second surface of the pipe.
